(19) United States
(12) Patent Application Publication
(10) Pub. No.: US 2026/0046676 A1
(43) Pub. Date: Feb. 12, 2026

(54) Quality-of-Experience Based Scheduling

(71) Applicant: Dell Products L.P., Round Rock, TX (US)

(72) Inventors: Yasser AlEryani, Kanata (CA); Satish Venkob, Mississauga (CA); Mostafa Mouawad, New Cairo (EG)

(21) Appl. No.: 18/796,201

(22) Filed: Aug. 6, 2024

(51) Int. Cl. H04W 28/02; H04W 72/20; H04W 72/543

(52) U.S. Cl. CPC H04W 28/0268; H04W 72/20; H04W 72/543

(57) ABSTRACT

A system can receive tactile correlation coefficients from at least one user equipment, the tactile correlation coefficients being generated by a trained deep reinforcement learning model, wherein the tactile correlation coefficients indicate respective correlations of respective outputs of an extended reality application of an extended reality application session established with the at least one user equipment via a broadband cellular network. The system can schedule data to transmit to the at least one user equipment based on the tactile correlation coefficients, to produce a scheduling. The system can transmit the data to the at least one user equipment based on the scheduling.

### BACKGROUND

Broadband cellular networks can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive tactile correlation coefficients from at least one user equipment, the tactile correlation coefficients being generated by a trained deep reinforcement learning model, wherein the tactile correlation coefficients indicate respective correlations of respective outputs of an extended reality application of an extended reality application session established with the at least one user equipment via a broadband cellular network. The system can schedule data to transmit to the at least one user equipment based on the tactile correlation coefficients, to produce a scheduling. The system can transmit the data to the at least one user equipment based on the scheduling.

An example method can comprise facilitating, by a system comprising at least one processor, receiving tactile correlation coefficients from a user equipment, the tactile correlation coefficients being generated by a trained deep reinforcement learning model, wherein the tactile correlation coefficients indicate respective correlations of respective outputs of an extended reality application of an extended reality application session, and wherein the extended reality application session is facilitated with the user equipment via a broadband cellular network. The method can further comprise scheduling, by the system, data to transmit to the user equipment based on the tactile correlation coefficients, to produce a scheduling. The method can further comprise facilitating, by the system, transmitting the data to the user equipment based on the scheduling.

An example non-transitory computer-readable medium can comprise instructions that, in response to execution, cause a system comprising a processor to perform operations. These operations can comprise receiving tactile correlation coefficients from a user equipment, the tactile correlation coefficients being generated by a machine learning model, wherein the tactile correlation coefficients indicate respective correlations of respective outputs of an extended reality application of an extended reality application session, and wherein the extended reality application session is facilitated with the user equipment via network equipment of a broadband cellular network. These operations can further comprise scheduling data to transmit to the user equipment based on the tactile correlation coefficients.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate QoE based scheduling, in accordance with an embodiment of this disclosure;

FIG. 2 illustrates an example system architecture of extended reality (XR) application flows, that can facilitate QoE based scheduling, in accordance with an embodiment of this disclosure;

FIG. 3 illustrates an example process flow for determining a video-audio covariance, and that can facilitate QoE based scheduling, in accordance with an embodiment of this disclosure;

FIG. 4 illustrates an example process flow for determining a video-haptic feedback covariance, and that can facilitate QoE based scheduling, in accordance with an embodiment of this disclosure;

FIG. 5 illustrates an example process flow for determining an audio-haptic feedback covariance, and that can facilitate QoE based scheduling, in accordance with an embodiment of this disclosure;

FIG. 6 illustrates an example table for determining an audio-haptic feedback covariance, and that can facilitate QoE based scheduling, in accordance with an embodiment of this disclosure;

FIG. 7 illustrates an example system architecture for machine learning model training, and that can facilitate QoE based scheduling, in accordance with an embodiment of this disclosure;

FIG. 8 illustrates an example system architecture for machine learning model inference, and that can facilitate QoE based scheduling, in accordance with an embodiment of this disclosure;

FIG. 9 illustrates another example system architecture for machine learning model training, and that can facilitate QoE based scheduling, in accordance with an embodiment of this disclosure;

FIG. 10 illustrates another example system architecture for machine learning model training, and that can facilitate QoE based scheduling, in accordance with an embodiment of this disclosure;

FIG. 11 illustrates an example process flow that can facilitate QoE based scheduling, in accordance with an embodiment of this disclosure;

FIG. 12 illustrates another example process flow that can facilitate QoE based scheduling, in accordance with an embodiment of this disclosure;

FIG. 13 illustrates another example process flow that can facilitate QoE based scheduling, in accordance with an embodiment of this disclosure; and

FIG. 14 illustrates an example block diagram of a computer operable to execute an embodiment of this disclosure.

### DETAILED DESCRIPTION

### Overview

The examples herein generally relate to fifth generation new radio (5G NR) broadband cellular communications. It can be appreciated that they can be applied to other types of broadband cellular communications, such as sixth generation (6G) technologies, and more generally to wireless communications.

In extended reality (XR) applications via a broadband cellular network, the delivery of diverse quality of service (QOS) flows such as video, audio, and haptic feedback can be interdependent, which can prompt strategic management during both uplink (UL) and downlink (DL) scheduling processes. These QoS flows can be intrinsically linked, which can influence the cumulative user experience. It can be that users can withstand certain degrees of visual and auditory imperfections, and this can be leveraged according to the present techniques by giving precedence to the scheduling of services that are sensitive to delays. To quantify user experience in a comprehensive manner, the present techniques can utilize a quality of experience (QoE) assessment technique that encapsulates the user's sensory perception. This QoE data can be conveyed to a gNodeB (gNB) medium access control (MAC) scheduler via MAC Control Elements (CEs), facilitating refined scheduling optimizations. In some examples, machine learning can be implemented to provide mechanism for translating physical key performance indicators (KPIs) into actionable scheduling commands, thereby enhancing the overall efficacy of XR applications.

Extended reality (XR) applications can include virtual reality (VR), augmented reality (AR), and mixed reality (MR) applications. These immersive applications can combine visual, auditory, and haptic elements to create interactive virtual environments. However, ensuring a high-quality user experience in XR applications can be challenging due to diverse QoS requirements of different data flows and a real-time nature of user interactions. The present techniques can be implemented to enhance QoE in XR applications.

### Example Architectures, Process Flows, and Tables

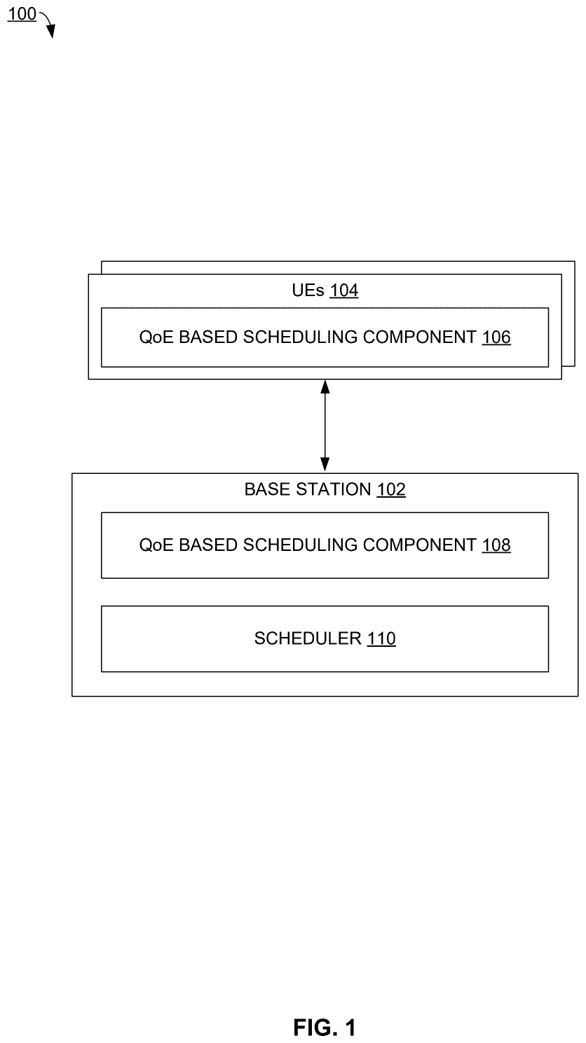

FIG. 1 illustrates an example system architecture 100 that can facilitate QoE based scheduling, in accordance with an embodiment of this disclosure.

System architecture 100 comprises base station 102 and UEs 104. In turn, base station 102 comprises QoE based scheduling component 108 and scheduler 110. And UEs 104 comprises QoE based scheduling component 106.

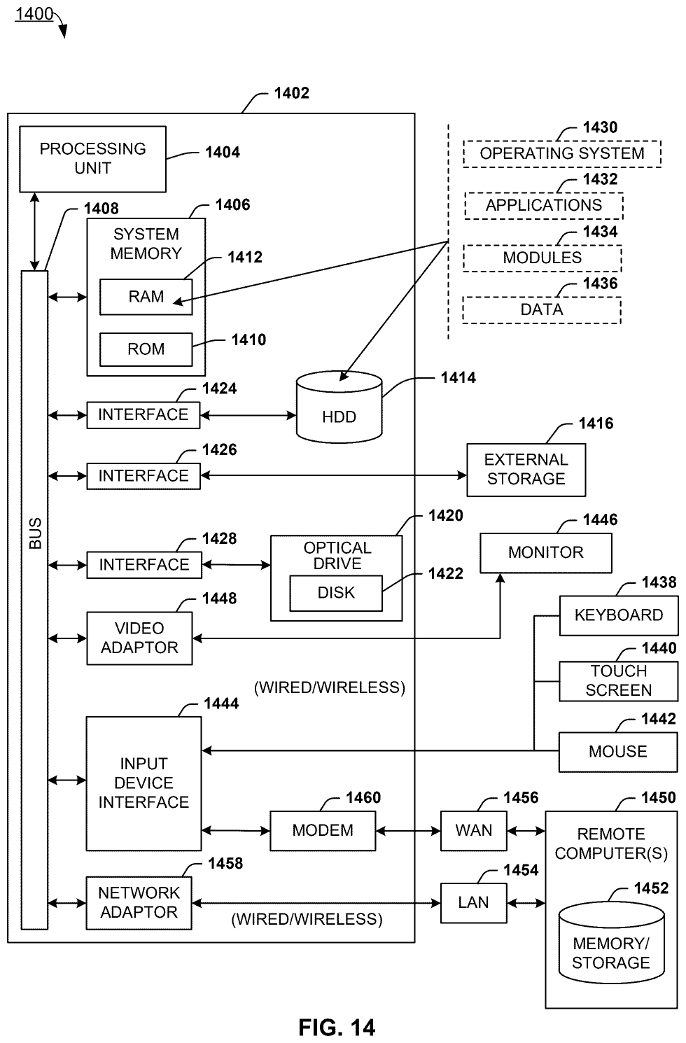

Each of base station 102 and/or UEs 104 can be implemented with part(s) of computing environment 1400 of FIG. 14.

QoE based scheduling component 108 can instruct scheduler 110 on how to schedule XR data flows (e.g., a video flow, an audio flow, and a haptic flow) to a UE of UEs 104 to facilitate a high QoE. QoE based scheduling component 106 can determine how XR flows at a UE of UEs 104 are correlated, and provide that information to QoE based scheduling component 108 to aid in the scheduling.

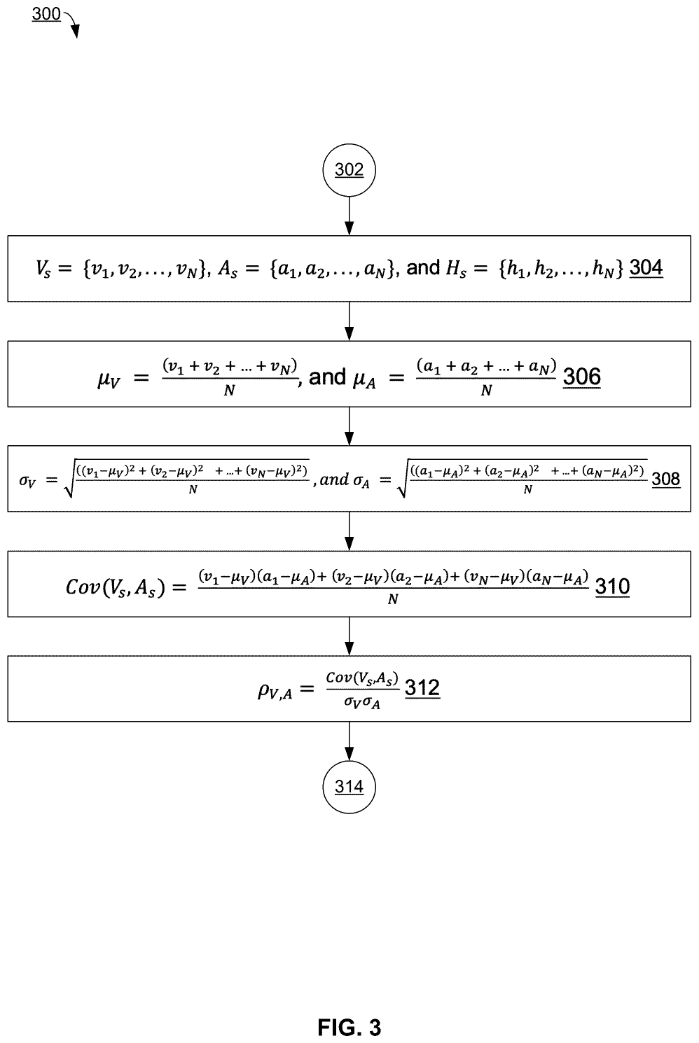

In some examples, QoE based scheduling component 108 can implement part(s) of the process flows of FIGS. 3-5 and/or 10-12 to facilitate QoE based scheduling.

It can be appreciated that system architecture 100 is one example system architecture for QoE based scheduling, and that there can be other system architectures that facilitate QoE based scheduling.

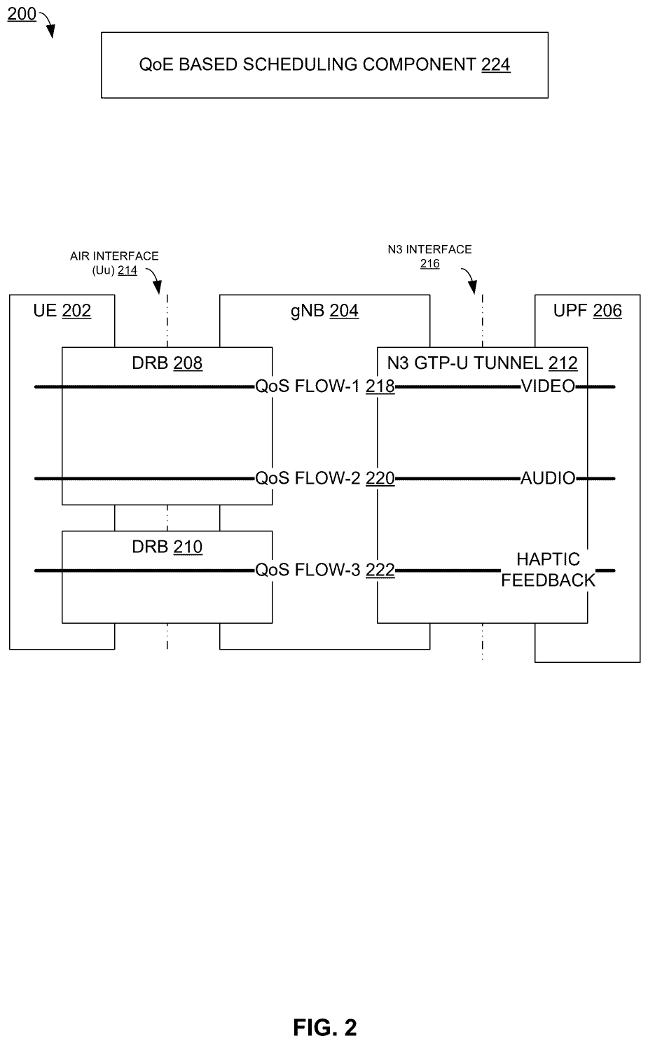

FIG. 2 illustrates an example system architecture 200 of extended reality (XR) application flows, that can facilitate QoE based scheduling, in accordance with an embodiment of this disclosure. In some examples, one or more embodiments of system architecture 200 can be implemented by system architecture 100 of FIG. 1, or computing environment 1400 of FIG. 14.

System architecture 200 comprises UE 202, gNB 204, user plane function (UPF) 206, data radio bearer (DRB) 208, DRB 210, N3 General Packet Radio Service (GPRS) Tunneling Protocol for user plane (N3 GTP-U; where a N3 interface can support user plane connectivity between a 5G radio access network (RAN) and a 5G core (5GC)) tunnel 212, air interface (Uu) 214, N3 interface 216, QoS flow-1 218 (video), QoS flow-2 220 (audio), QoS flow-3 222 (haptic feedback), and QoE based scheduling component 224 (which can be similar to QoE based scheduling component 108 of FIG. 1).

In XR applications, various QoS flows, such as video, audio, and haptic feedback, can be highly correlated with each other. For example, the visual elements can influence the perception of audio and haptic feedback, and vice versa. Understanding and considering this correlation can be utilized when scheduling these flows during uplink and downlink transmissions. By optimizing the delivery of each flow based on their interdependencies, it can be possible to enhance the overall user experience.

The human body can have a certain tolerance for image and sound distortions, such as in XR applications where a focus can be on immersion rather than pixel-perfect accuracy. This tolerance can be leveraged by a gNB MAC scheduler to prioritize time-critical applications and allocate resources accordingly. By giving more prioritization to critical flows, such as real-time audio or fast-changing visuals, slight distortions in less critical flows can be tolerated without significantly affecting the user experience.

To measure and quantify the overall user experience in XR applications, a comprehensive Quality of Experience (QoE) method can be implemented. This can take into account various factors, including latency, frame rate, audio clarity, haptic responsiveness, and overall immersion. By capturing the holistic perception of users, the QoE measurement can provide feedback on the effectiveness of the system in delivering a satisfying user experience.

Machine learning techniques can be implemented for optimizing (or improving) the performance of XR applications. By establishing a mapping between physical KPIs and digital commands, machine learning models can enable a scheduler to make data-driven decisions. Leveraging historical data and real-time feedback, the machine learning model can continuously adapt and improve a scheduling strategy, leading to enhanced QoE in XR applications.

By considering a correlation between QoS flows, exploiting human tolerance to distortions, and utilizing machine learning techniques for optimization, it can be possible to enhance the overall QoE in XR applications.

The present techniques can implement a deep reinforcement learning (DRL) machine learning model. This can include a fine-tuning hyperparameter, and designing state vectors, reward function, and action space.

The present techniques can be implemented to facilitate correlation aware scheduling. By considering the correlations between different QoS flows, such as video, audio, and haptic feedback, a scheduler can optimize (or otherwise improve) the delivery of each flow to enhance the overall user experience. This correlation-aware approach can ensure that interdependencies between flows are considered, leading to improved synchronization and coherence in the XR experience.

It can be that a correlation under consideration is related to statistical variations on traffic pattern for each QoS flow, irrespective of link quality. This, along with other metrices, can facilitate an immersive experience for XR UEs.

The present techniques can be implemented to facilitate human perception-driven resource allocation. The present techniques can leverage human tolerance to distortions in XR applications. It can be that, by prioritizing time-critical applications and allocating resources accordingly, slight distortions in less critical flows can be tolerated without significantly impacting the user experience. This human perception-driven resource allocation approach can ensure that resources are allocated in a way that maximizes (or improves) the perceived quality and immersion for users. It can be appreciated that, where optimizing or maximizing (or other superlatives) are disclosed with respect to the present techniques, that there can be examples of the present techniques where an improvement in that area is implemented.

The present techniques can be implemented to facilitate comprehensive QoE measurement. QoE measurement according to the present techniques can capture a holistic perception of users in XR applications. This can go beyond traditional metrics and incorporate factors such as latency, frame rate, audio clarity, haptic responsiveness, and overall immersion. This comprehensive QoE measurement can provide valuable feedback to a scheduler, enabling it to optimize resource allocation based on user-centric criteria, and continuously improve the user experience.

The present techniques can be implemented to facilitate machine learning (ML) based optimization for a scheduling process in XR applications. By training models on historical data, real-time feedback, and contextual information, a machine learning model can learn to make data-driven decisions for resource allocation. The model can continuously adapt and improve its scheduling strategy, leading to enhanced QoE. This machine learning-based optimization approach can provide a more adaptive and intelligent solution compared to prior approaches that utilize rule-based heuristics.

Overall, the present techniques can facilitate an integration of correlation-aware scheduling, human perception-driven resource allocation, comprehensive QoE measurement, and machine learning-based optimization. The present techniques can be implemented to enhance user experience in XR applications by considering the interdependencies between flows, exploiting human perceptual sensitivities, measuring QoE holistically, and leveraging machine learning for intelligent resource allocation.

An example system that can be used to implement part(s) of the present techniques for an XR session can comprise the following components:
XR application: this can comprise immersive application that combines virtual reality (VR), augmented reality (AR), or mixed reality (MR) elements to provide an interactive experience to the user.
sensor and input devices: sensors such as cameras, microphones, and haptic devices can capture user input and environmental data to provide real-time feedback.
network infrastructure: network infrastructure can enable communication between the XR application and remote servers or cloud resources for data processing and content delivery.
scheduling and optimization component: This can be responsible for optimizing the allocation of system resources, such as bandwidth, processing power, and latency, based on the present techniques.
ML component: this can utilize machine learning techniques, such as supervised learning or reinforcement learning, to train models and make intelligent decisions for resource allocation.

An example technology stack that can be used to implement part(s) of the present techniques for an XR session can comprise the following components:
XR development platforms: these can be platforms that provide tools and frameworks for creating XR applications.
networking technologies: these can comprise networking protocols and technologies, such as Transmission Control Protocol/Internet Protocol (TCP/IP), User Datagram Protocol (UDP), or Web Real-Time Communications (WebRTC) protocols, for data transmission between an XR application and remote servers.
machine learning frameworks: these frameworks can be utilized for building and deploying machine learning models.
data collection and processing: this can comprise techniques for collecting and processing real-time data from sensors and input devices, including image processing, audio analysis, and haptic feedback processing.
cloud computing and edge computing: this can comprise cloud resources and edge computing infrastructure can be leveraged for offloading computational tasks, reducing latency, and enhancing scalability.

FIG. 3 illustrates an example process flow 300 for determining a video-audio covariance, and that can facilitate QoE based scheduling, in accordance with an embodiment of this disclosure. In some examples, one or more embodiments of process flow 300 can be implemented by system architecture 100 of FIG. 1, or computing environment 1400 of FIG. 14.

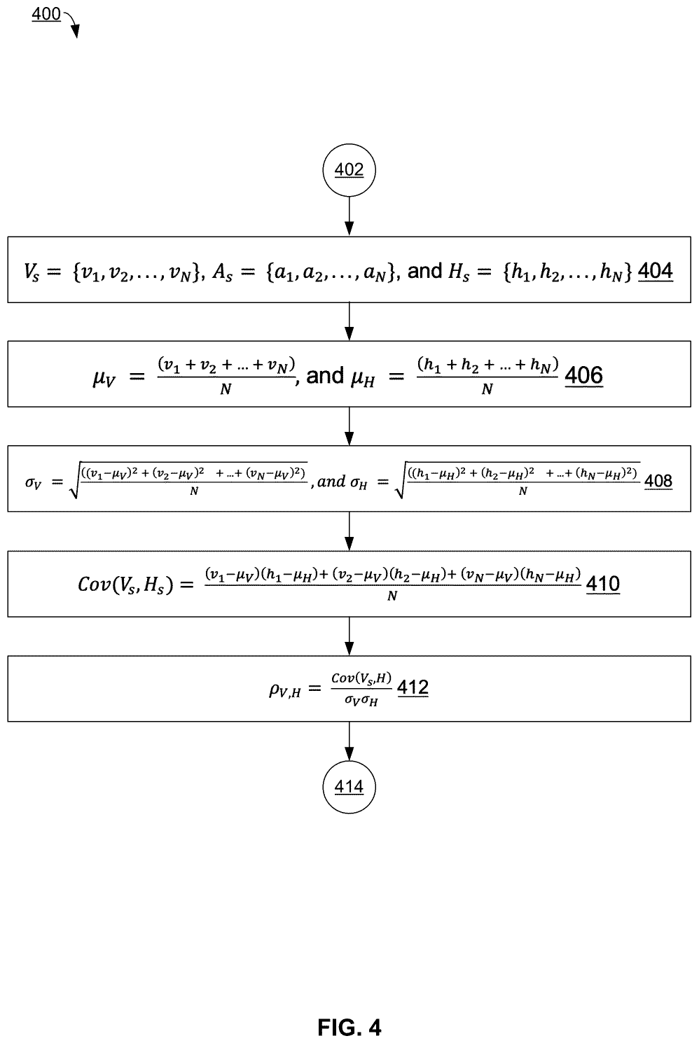

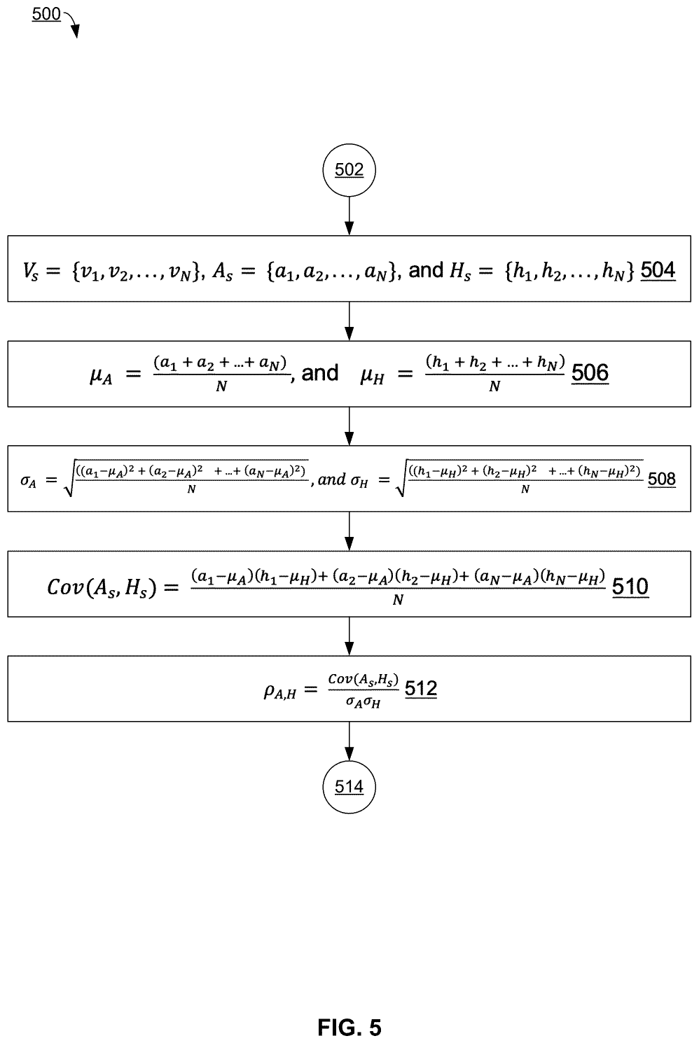

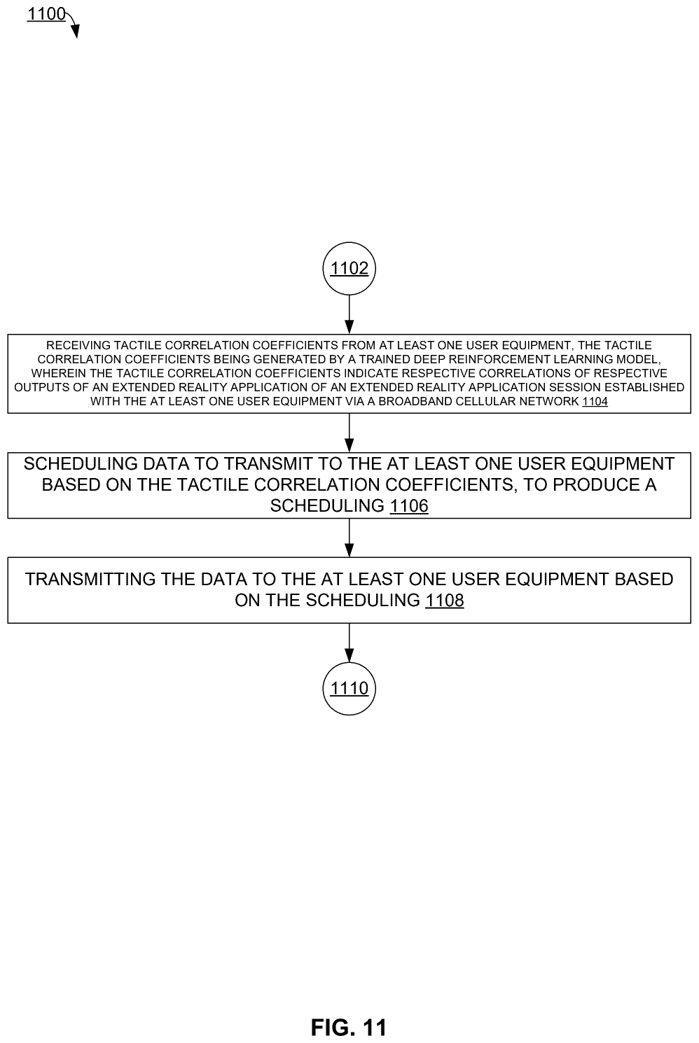

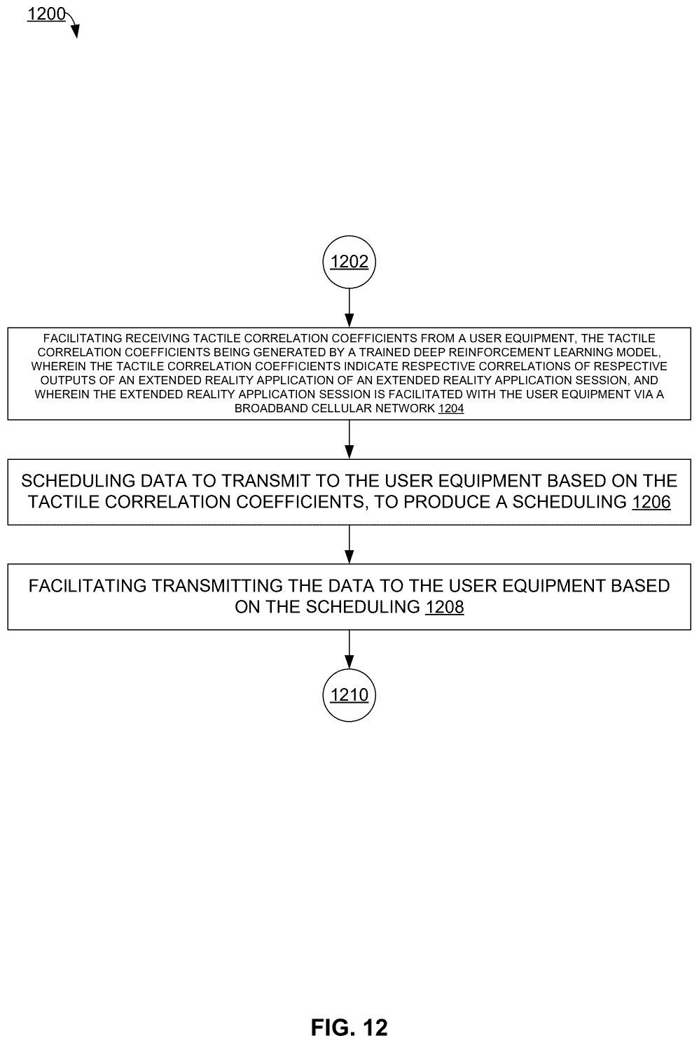

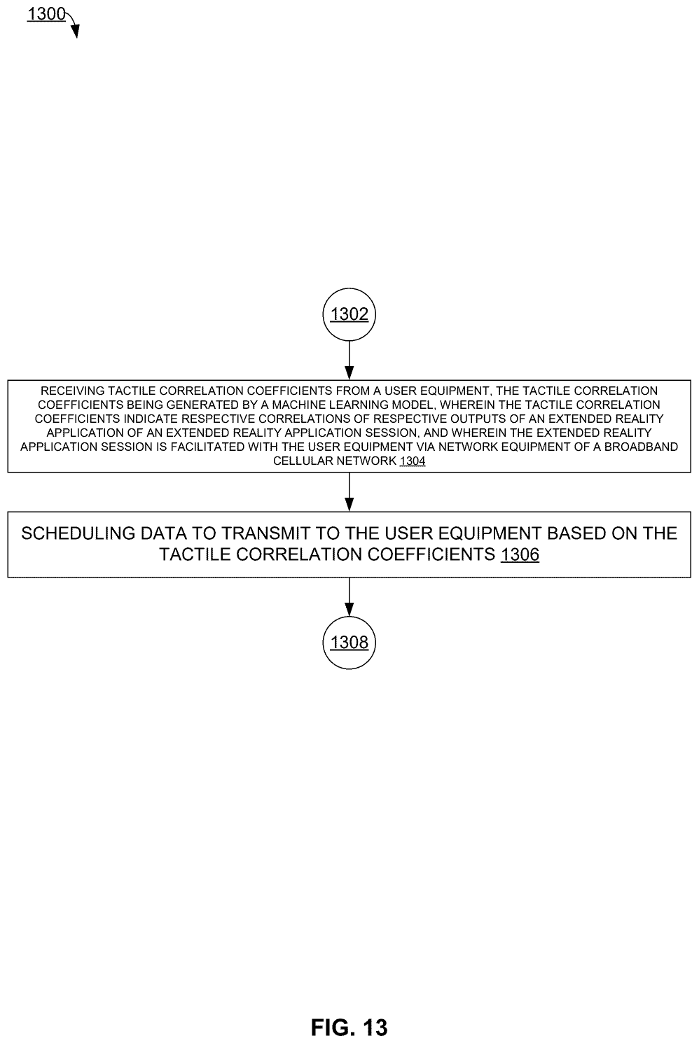

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of process flow 400 of FIG. 4, process flow 500 of FIG. 5, process flow 1100 of FIG. 11, process flow 1200 of FIG. 12, and/or process flow 1300 of FIG. 13.

Process flow 300 begins with 302, and moves to operation 304.

Operation 304 depicts determining samples Vₛ={v₁, v₂, . . . , v_{N}}, Aₛ={a₁, a₂, . . . , a_{N}}, and Hₛ={h₁, h₂, . . . , h_{N}}.

After operation 304, process flow 300 moves to operation 306.

Operation 306 depicts determining

$${μ}_{V} = \frac{( {v}_{1} + {v}_{2} + … + {v}_{N} )}{N} , and {μ}_{A} = \frac{( {a}_{1} + {a}_{2} + … + {a}_{N} )}{N} .$$

After operation 306, process flow 300 moves to operation 308.

Operation 308 depicts determining

$${σ}_{V} = \sqrt{\frac{( {( {v}_{1} - {μ}_{V} )}^{2} + {( {v}_{2} - {μ}_{V} )}^{2} + … + {( {v}_{N} - {μ}_{V} )}^{2} )}{N}} , and$$

$${σ}_{A} = \sqrt{\frac{( {( {a}_{1} - {μ}_{A} )}^{2} + {( {a}_{2} - {μ}_{A} )}^{2} + … + {( {a}_{N} - {μ}_{A} )}^{2} )}{N}} .$$

After operation 308, process flow 300 moves to operation 310.

Operation 310 depicts determining

$$Cov ( {V}_{s} , {A}_{s} ) = \frac{( {v}_{1} - {μ}_{V} ) ( {a}_{1} - {μ}_{A} ) + ( {v}_{2} - {μ}_{V} ) ( {a}_{2} - {μ}_{A} ) + ( {v}_{N} - {μ}_{V} ) ( {a}_{N} - {μ}_{A} )}{N} .$$

After operation 310, process flow 300 moves to operation 312.

Operation 312 depicts determining

$${ρ}_{V , A} = \frac{Cov ( {V}_{s} , {A}_{s} )}{{σ}_{V} {σ}_{A}} .$$

After operation 312, process flow 300 moves to 314, where process flow 300 ends.

The following techniques can be implemented to convert between correlation measurements among different QoS flows of an XR application and QoE KPIs.

Measuring the correlation among Quality of Service (QOS) flows over XR applications can be done using techniques such as correlation coefficient. An example correlation coefficient is Pearson's correlation coefficient, which measures a linear relationship between two variables. In the context of QoS flows, a correlation coefficient between pairs of flows can be determined to quantify their correlation.

Consider QoS flows, A, B and C, for video, audio, and haptic feedback, respectively. in this example, a set of N samples for each flow has been collected. The samples of flow A can be represented as:

$${V}_{s} = \{ {v}_{1} , {v}_{2} , … , {v}_{N} \}$$

$${A}_{s} = \{ {a}_{1} , {a}_{2} , … , {a}_{N} \}$$

$${H}_{s} = \{ {h}_{1} , {h}_{2} , … , {h}_{N} \}$$

In other examples, four different metrices can be used to collect samples.

The following is an example four-step technique to correlate flows.

In Step 1, determine the means of video, audio, and haptic feedback, respectively, as flows:

$${μ}_{V} = \frac{( {v}_{1} + {v}_{2} + … + {v}_{N} )}{N} ,$$

$${μ}_{A} = \frac{( {a}_{1} + {a}_{2} + … + {a}_{N} )}{N} ,$$

$${μ}_{H} = \frac{( {h}_{1} + {h}_{2} + … + {h}_{N} )}{N} .$$

In Step 2, determine the standard deviations of the flows:

$${σ}_{V} = \sqrt{\frac{( {( {v}_{1} - {μ}_{V} )}^{2} + {( {v}_{2} - {μ}_{V} )}^{2} + … + {( {v}_{N} - {μ}_{V} )}^{2} )}{N}} ,$$

$${σ}_{A} = \sqrt{\frac{( {( {a}_{1} - {μ}_{A} )}^{2} + {( {a}_{2} - {μ}_{A} )}^{2} + … + {( {a}_{N} - {μ}_{A} )}^{2} )}{N}} ,$$

$${σ}_{H} = \sqrt{\frac{( {( {h}_{1} - {μ}_{H} )}^{2} + {( {h}_{2} - {μ}_{H} )}^{2} + … + {( {h}_{N} - {μ}_{H} )}^{2} )}{N}} .$$

In Step 3, determine the mutual covariance among different flows:

$$Cov ( {V}_{s} , {A}_{s} ) = \frac{( {v}_{1} - {μ}_{V} ) ( {a}_{1} - {μ}_{A} ) + ( {v}_{2} - {μ}_{V} ) ( {a}_{2} - {μ}_{A} ) + ( {v}_{N} - {μ}_{V} ) ( {a}_{N} - {μ}_{A} )}{N} ,$$

$$Cov ( {V}_{s} , {H}_{s} ) = \frac{( {v}_{1} - {μ}_{V} ) ( {h}_{1} - {μ}_{H} ) + ( {v}_{2} - {μ}_{V} ) ( {h}_{2} - {μ}_{H} ) + ( {v}_{N} - {μ}_{V} ) ( {h}_{N} - {μ}_{H} )}{N} ,$$

$$Cov ( {A}_{s} , {H}_{s} ) = \frac{( {a}_{1} - {μ}_{A} ) ( {h}_{1} - {μ}_{H} ) + ( {a}_{2} - {μ}_{A} ) ( {h}_{2} - {μ}_{H} ) + ( {a}_{N} - {μ}_{A} ) ( {h}_{N} - {μ}_{H} )}{N} .$$

In Step 4, determine the correlation coefficient between video and audio flows:

$${ρ}_{V , A} = \frac{Cov ( {V}_{s} , {A}_{s} )}{{σ}_{V} {σ}_{A}} ,$$

$${ρ}_{V , H} = \frac{Cov ( {V}_{s} , H )}{{σ}_{V} {σ}_{H}} ,$$

$${ρ}_{A , H} = \frac{Cov ( {A}_{s} , {H}_{s} )}{{σ}_{A} {σ}_{H}} .$$

Upon calculating the correlation coefficients between video and audio (ρ_{V,A}), video and haptic (ρ_{V,H}), and audio and haptic (ρ_{A,H}), these values can be mapped into a digital MAC command. This is described in more detail in a following section.

FIG. 4 illustrates an example process flow 400 for determining a video-haptic feedback covariance, and that can facilitate QoE based scheduling, in accordance with an embodiment of this disclosure. In some examples, one or more embodiments of process flow 400 can be implemented by system architecture 100 of FIG. 1, or computing environment 1400 of FIG. 14.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of process flow 300 of FIG. 3, process flow 500 of FIG. 5, process flow 1100 of FIG. 11, process flow 1200 of FIG. 12, and/or process flow 1300 of FIG. 13.

Process flow 400 begins with 402, and moves to operation 404.

Operation 404 depicts determining samples Vₛ={v₁, v₂, . . . , v_{N}}, Aₛ={a₁, a₂, . . . , a_{N}}, and Hₛ={h₁, h₂, . . . , h_{N}}.

After operation 404, process flow 400 moves to operation 406.

Operation 406 depicts determining

$${μ}_{V} = \frac{( {v}_{1} + {v}_{2} + … + {v}_{N} )}{N} , and {μ}_{H} = \frac{( {h}_{1} + {h}_{2} + … + {h}_{N} )}{N} .$$

After operation 406, process flow 400 moves to operation 408.

Operation 408 depicts determining

$${σ}_{V} = \sqrt{\frac{( {( {v}_{1} - {μ}_{V} )}^{2} + {( {v}_{2} - {μ}_{V} )}^{2} + … + {( {v}_{N} - {μ}_{V} )}^{2} )}{N}} , and$$

$${σ}_{H} = \sqrt{\frac{( {( {h}_{1} - {μ}_{H} )}^{2} + {( {h}_{2} - {μ}_{H} )}^{2} + … + {( {h}_{N} - {μ}_{H} )}^{2} )}{N}} .$$

After operation 408, process flow 400 moves to operation 410.

Operation 410 depicts determining

$$Cov ( {V}_{s} , {H}_{s} ) = \frac{( {v}_{1} - {μ}_{V} ) ( {h}_{1} - {μ}_{H} ) + ( {v}_{2} - {μ}_{V} ) ( {h}_{2} - {μ}_{H} ) + ( {v}_{N} - {μ}_{V} ) ( {h}_{N} - {μ}_{H} )}{N} .$$

After operation 410, process flow 400 moves to operation 412.

Operation 412 depicts determining

$${ρ}_{V , H} = \frac{Cov ( {V}_{s} , H )}{{σ}_{V} {σ}_{H}} .$$

After operation 412, process flow 400 moves to 414, where process flow 400 ends.

FIG. 5 illustrates an example process flow 500 for determining an audio-haptic feedback covariance, and that can facilitate QoE based scheduling, in accordance with an embodiment of this disclosure. In some examples, one or more embodiments of process flow 500 can be implemented by system architecture 100 of FIG. 1, or computing environment 1400 of FIG. 14.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 300 of FIG. 3, process flow 400 of FIG. 4, process flow 1100 of FIG. 11, process flow 1200 of FIG. 12, and/or process flow 1300 of FIG. 13.

Process flow 500 begins with 502, and moves to operation 504.

Operation 504 depicts determining samples Vₛ={v₁, v₂, . . . , v_{N}}, Aₛ={a₁, a₂, . . . , a_{N}}, and Hₛ={h₁, h₂, . . . , h_{N}}.

After operation 504, process flow 500 moves to operation 506.

Operation 506 depicts determining

$${μ}_{A} = \frac{( {a}_{1} + {a}_{2} + … + {a}_{N} )}{N} , and {μ}_{H} = \frac{( {h}_{1} + {h}_{2} + … + {h}_{N} )}{N} .$$

After operation 506, process flow 500 moves to operation 508.

Operation 508 depicts determining

$${σ}_{A} = \sqrt{\frac{( {( {a}_{1} - {μ}_{A} )}^{2} + {( {a}_{2} - {μ}_{A} )}^{2} + … + {( {a}_{N} - {μ}_{A} )}^{2} )}{N}} , and$$

$${σ}_{H} = \sqrt{\frac{( {( {h}_{1} - {μ}_{H} )}^{2} + {( {h}_{2} - {μ}_{H} )}^{2} + … + {( {h}_{N} - {μ}_{H} )}^{2} )}{N}} .$$

After operation 508, process flow 500 moves to operation 510.

Operation 510 depicts determining

$$Cov ( {A}_{s} , {H}_{s} ) = \frac{( {a}_{1} - {μ}_{A} ) ( {h}_{1} - {μ}_{H} ) + ( {a}_{2} - {μ}_{A} ) ( {h}_{2} - {μ}_{H} ) + ( {a}_{N} - {μ}_{A} ) ( {h}_{N} - {μ}_{H} )}{N} .$$

After operation 510, process flow 500 moves to operation 512.

Operation 512 depicts determining

$${ρ}_{AH} = \frac{Cov ( {A}_{s} , {H}_{s} )}{{σ}_{A} {σ}_{H}} .$$

After operation 512, process flow 500 moves to 514, where process flow 500 ends.

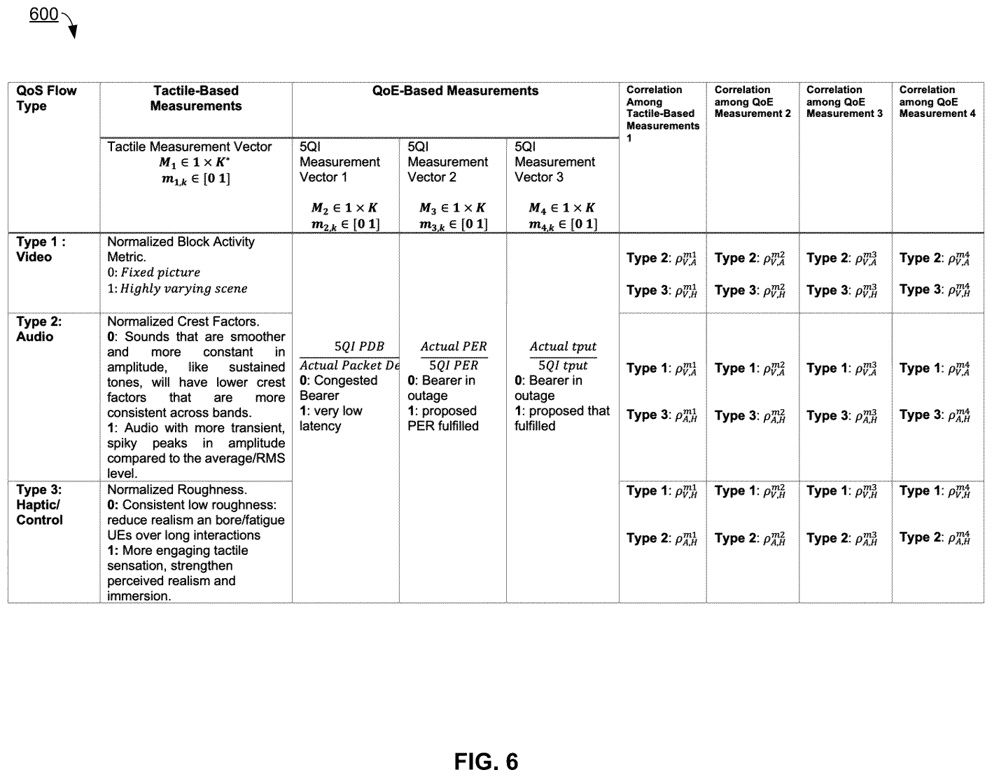

FIG. 6 illustrates an example table 600 for determining an audio-haptic feedback covariance, and that can facilitate QoE based scheduling, in accordance with an embodiment of this disclosure. In some examples, one or more embodiments of table 600 can be implemented by system architecture 100 of FIG. 1, or computing environment 1400 of FIG. 14.

To facilitate an immersive QoE performance for a XR UE, a set of measurements that impact the overall performance of XR system can be selected. These measurements can be tailored for video, audio, and haptic/control QoS flows in both UL and DL.

Tactile-based metrices can be selected as follows. For an optimal immersive experience, there can be a real-time feedback from XR UE toward a gNB that continuously reflects the correlation among video, audio, and haptic/control signaling, both in UL and DL. These can be based on statistics generated by a relative codec unit at an XR device. This can be captured in a human-based tactile metrices as follows.

A tactile video experience can be considered. For this purpose, block activity metrics from video codecs can provide insights into whether scenes are more fixed/static or varying over time.

With fixed or static scenes, there can be less change between frames compared to more dynamic scenes. This can result in many blocks during encoding having very low or zero activity/texture. The percentage of zero/low activity blocks can be higher compared with more dynamic scenes.

As scenes become more dynamic with movement (changing details, etc.), there can be more variation between frames. This can mean that more blocks will have non-zero transform coefficients during encoding, representing the changing textures/intensities.

The average block activity level across the frame can tend to be higher for varying scenes compared to static ones. Fixed scenes can see block activity remain consistently low and consistent across the frame. Varying scenes can exhibit more temporal fluctuations in block activity levels.

Scene change detection by an encoder can also provide clues: fixed scenes can result in longer durations of intra/inter coding without detected changes compared to rapidly varying content.

That is, with respect to a tactile video experience, a higher percentage of zero/low activity blocks can indicate more static content; a higher average block activity can indicate more dynamics/variation; more temporal fluctuations in block metrics can denote more temporal change; and frequent scene changes vs long durations of consistent coding can show variability. Analyzing these block-level statistics extracted from encoder metadata over time can characterize whether content and scenes are varying rapidly or remaining more fixed on average.

A tactile audio experience can be considered. Crest factors measured per frequency band can provide insights into the varying nature of sound waves over time. Higher crest factors can indicate sounds with more transient, spiky peaks in amplitude compared to the average/root mean squared (RMS) level. Spiky transients can be more likely to appear in only certain frequency bands rather than evenly spread out. For example, sharp percussion hits can cause peaks mainly in high frequencies.

Lower crest factors can indicate sounds that are smoother and more constant in amplitude, like sustained tones, which can have lower crest factors that are more consistent across bands. Rapidly alternating or irregular sounds, like bursts of noise, can be more likely to cause crest factor peaks to shift between bands over short time periods as the energy distribution changes. Dynamic ranges with sharp attacks and decays, like babble or applause, can cause crest factors that fluctuate more noticeably in certain bands as envelopes vary over time. Steady sounds, even if complex in timbre, can tend to produce crest factors that remain relatively constant from frame to frame across most or all bands.

That is, with respect to a tactile audio experience, analyzing temporal variations of crest factors per frequency band can reveal properties like impulsiveness v. smoothness; spectral distributions changing rapidly or remaining stable; dynamic range fluctuations; and regular v. irregular/bursty waveforms. This can provide insights into a varying versus static nature of underlying amplitude envelopes in different parts of the audio spectrum.

A tactile haptic/control experience can be considered.

Roughness measures in the context of coded haptic signals can provide insights into varying playback rates. Roughness: can be determined from temporal derivatives or irregularity measurements of the haptic signal over short time intervals. Higher roughness values can imply a more rapidly fluctuating, irregular tactile waveform that can be rougher/grainier during playback. Static waveforms like a constant vibration can produce low, consistent roughness values over time.

Waveforms that contain rapid bursts, transients, or changes in texture/amplitude can cause roughness to spike and fluctuate more noticeably. Smoothly varying signals like simple oscillations or enveloped textures can produce intermediate roughness levels that change gradually over time. Complex, random, or multi-frequency waveforms can tend to yield roughness measurements that are higher on average but also vary significantly from moment to moment. Spatial differences in roughness can also indicate dynamic patterns, like a texture rolling or moving across the skin.

That is, analyzing the temporal properties of roughness metrics extracted from coded haptic signals can provide clues about: smooth v. rough/complex felt textures; gradual changes or rapid bursts/transitions; regular waves v. random/noisy signals; and static textures v. dynamic temporal patterns. This can help characterize perception of rapidly or slowly varying playback rates.

Further to using tactile correlation metrices at the UE, in some examples, the following 5G QoS Identifier (5QI) related metrices: packet delay budget, packet error rate, and guaranteed bit rate.

Table 600 illustrates example KPIs for an XR application that can be used as an input/output for the ML system.

To further illustrate the relation between correlation of two metrices from two QoS flows related to XR UEs, the following examples can be utilized to interpret different correlation values for any given set of metrices among two QoS flows.

A video-audio correlation (ρ_{V,A}) can be implemented as follows. The correlation between video and audio in XR applications can directly impact the synchronization and coherence of the multimedia experience. Here are some guidelines for interpreting correlation values between video and audio in relation to Quality of Experience (QoE).

### Positive Correlation (ρ_{V,A}>0):

Strong positive correlation (0.7≤ρ_{V,A}≤1.0): A strong positive correlation can indicate that as the video quality improves or degrades, the audio quality can tend to show a similar trend. In terms of QoE, this can suggest that a high level of correlation between video and audio can contribute to a more immersive and enjoyable user experience. Users can perceive a coherent and synchronized multimedia experience when the visual and auditory components are tightly coupled.
Moderate positive correlation (0.3≤ρ<0.7): A moderate positive correlation can suggest a moderate relationship between video and audio quality. Changes in one component can have a moderate influence on the other. In terms of QoE, this can imply that maintaining a moderate positive correlation can contribute to a reasonably coherent user experience, although it can be that there can be some instances where minor discrepancies between video and audio quality are observed.
Weak positive correlation (0≤ρ_{V,A}<0.3): A weak positive correlation can indicate a minimal relationship between video and audio quality. Changes in one component can have limited impact on the other. In terms of QoE, this can suggest that the perception of video and audio quality can be relatively independent of each other, and minor discrepancies between them might not significantly impact the overall user experience.

### Negative Correlation (ρ<0):

Strong negative correlation (−1.0≤ρ_{V,A}≤−0.7): A strong negative correlation can imply an inverse relationship between video and audio quality. As the video quality improves or degrades, the audio quality can tend to show an opposite trend. In terms of QoE, this can suggest that inconsistent or conflicting video-audio experiences can negatively impact user perception. It can be that maintaining a strong negative correlation is generally not desirable for delivering a coherent and immersive user experience.
Moderate negative correlation (−0.7<ρ_{V,A}≤−0.3): A moderate negative correlation can suggest a moderate inverse relationship between video and audio quality. Changes in one component can have a moderate impact on the other. In terms of QoE, this can imply that there might be trade-offs or compromises between video and audio quality, which can impact user perception and satisfaction.
Weak negative correlation (−0.3<ρ_{V,A}≤0): A weak negative correlation can indicate a minimal inverse relationship between video and audio quality. Changes in one component can have limited influence on the other. In terms of QoE, this can suggest that video and audio quality can exhibit more independent behavior, and minor discrepancies between them might not significantly impact the overall user experience.

No correlation (ρ_{V,A}≈0): A correlation value close to 0 can indicate a lack of linear relationship between video and audio quality. That is, it can be that changes in one are not related to changes in the other. In terms of QoE, this can suggest that video and audio quality can vary independently, and minor discrepancies between them might not significantly impact the perception of the other component.

In some examples, correlation information can be considered in conjunction with other QoE evaluation techniques, user studies, and/or domain-specific knowledge to gain a comprehensive understanding of the impact of video-audio correlation on the overall user experience in XR applications.

A video-haptic feedback correlation (ρ_{V,H}) can be implemented as follows.

The following are example guidelines for interpreting correlation values between haptic feedback and video in relation to QoE.

### Positive Correlation (ρ>0):

Strong positive correlation (0.7≤ρ_{V,H}≤1.0): A strong positive correlation can suggest that as the haptic feedback and video are positively related, changes or improvements in one tend to correspond with changes or improvements in the other. In terms of QoE, this can indicate that a consistent and synchronized haptic-video experience is likely to enhance user perception and satisfaction.
Moderate positive correlation (0.3≤ρ_{V,H}<0.7): A moderate positive correlation can indicate a moderate relationship between haptic feedback and video. Changes in one can tend to be associated with changes in the other, but it can be that the relationship is not as strong as in the case of a strong positive correlation. In terms of QoE, this can suggest that there is a degree of coherence between the haptic and visual aspects, which can contribute to a more immersive and engaging user experience.
Weak positive correlation (0≤ρ_{V,H}<0.3): A weak positive correlation can suggest a minimal relationship between haptic feedback and video. Changes in one can have limited impact on the other. In terms of QoE, this can imply that the haptic and visual aspects can be relatively independent of each other, and the overall user experience might not be significantly affected by changes in one or the other.

### Negative Correlation (ρ_{V,H}<0):

Strong negative correlation (−1.0≤ρ_{V,H}≤−0.7): A strong negative correlation can indicate an inverse relationship between haptic feedback and video. As one improves or degrades, the other can tend to show an opposite trend. In terms of QoE, this can suggest that inconsistent or conflicting haptic-video experiences might negatively impact user perception and satisfaction. It can be that maintaining a strong negative correlation is not desirable for achieving a cohesive and immersive user experience.
Moderate negative correlation (−0.7<ρ_{V,H}≤−0.3): A moderate negative correlation can suggest a moderate inverse relationship between haptic feedback and video. Changes in one tend to be associated with changes in the other, but the relationship is not as strong as in the case of a strong negative correlation. In terms of QoE, this can imply that there can be trade-offs or compromises between haptic and visual aspects, which can impact user perception and satisfaction.
Weak negative correlation (−0.3<ρ_{V,H}≤0): A weak negative correlation can indicate a minimal inverse relationship between haptic feedback and video. Changes in one can have limited influence on the other. In terms of QoE, this can suggest that the haptic and visual aspects can exhibit more independent behavior, and changes in one might not significantly impact the perception of the other.

No correlation (ρ_{V,H}≈0): A correlation value close to 0 can indicate a lack of linear relationship between haptic feedback and video. It can be that changes in one are not related to changes in the other. In terms of QoE, this can suggest that the haptic and visual aspects can vary independently, and changes in one might not significantly impact the perception of the other.

An audio-haptic feedback correlation (ρ_{A,H}) can be implemented as follows. The correlation between audio and haptic feedback QoS flows in XR applications can provide insights into the relationship between the auditory and tactile aspects of the multimedia experience. The following are example guidelines for interpreting correlation values between audio and haptic feedback QoS flows.

### Positive Correlation (ρ_{A,H}>0):

Strong positive correlation (0.7≤ρ_{A,H}≤1.0): A strong positive correlation can suggest that as the audio QoS improves or degrades, the haptic feedback QoS can tend to show a similar trend. In terms of QoE, this can indicate that a high level of correlation between audio and haptic feedback QoS flows can contribute to a more immersive and coherent user experience. Users can perceive a synchronized and consistent multimedia experience when the auditory and tactile components are tightly coupled.
Moderate positive correlation (0.3≤ρ_{A,H}≤0.7): A moderate positive correlation can indicate a moderate relationship between audio and haptic feedback QoS flows. Changes in one aspect can have a moderate influence on the other. In terms of QoE, this can imply that maintaining a moderate positive correlation can contribute to a reasonably coherent user experience, although there can be some instances where minor discrepancies between audio and haptic feedback QoS are observed.
Weak positive correlation (0≤ρ_{A,H}≤0.3): A weak positive correlation can suggest a minimal relationship between audio and haptic feedback QoS flows. Changes in one aspect can have limited impact on the other. In terms of QoE, this can suggest that the perception of audio and haptic feedback QoS flows can be relatively independent of each other, and minor discrepancies between them might not significantly impact the overall user experience.

### Negative Correlation (ρ_{A,H}<0):

Strong negative correlation (−1.0≤ρ_{A,H}≤−0.7): A strong negative correlation can imply an inverse relationship between audio and haptic feedback QoS flows. As the audio QoS improves or degrades, the haptic feedback QoS can tend to show an opposite trend. In terms of QoE, this can suggest that inconsistent or conflicting audio-haptic feedback experiences might negatively impact user perception. In some examples, it can be that maintaining a strong negative correlation is generally not desirable for delivering a coherent and immersive user experience.
Moderate negative correlation (−0.7<ρ_{A,H}≤−0.3): A moderate negative correlation can suggest a moderate inverse relationship between audio and haptic feedback QoS flows. Changes in one aspect can have a moderate impact on the other. In terms of QoE, this can imply that there can be trade-offs or compromises between audio and haptic feedback QoS flows, which can impact user perception and satisfaction.
Weak negative correlation (−0.3<ρ_{A,H}≤0): A weak negative correlation can indicate a minimal inverse relationship between audio and haptic feedback QoS flows. Changes in one aspect can have limited influence on the other. In terms of QoE, this can suggest that audio and haptic feedback QoS flows can exhibit more independent behavior, and minor discrepancies between them might not significantly impact the overall user experience.

No correlation (ρ_{A,H}≈0): A correlation value close to 0 can indicate a lack of linear relationship between audio and haptic feedback QoS flows. Changes in one are not related to changes in the other. In terms of QoE, this can suggest that audio and haptic feedback QoS flows can vary independently, and minor discrepancies between them might not significantly impact the perception of the other component.

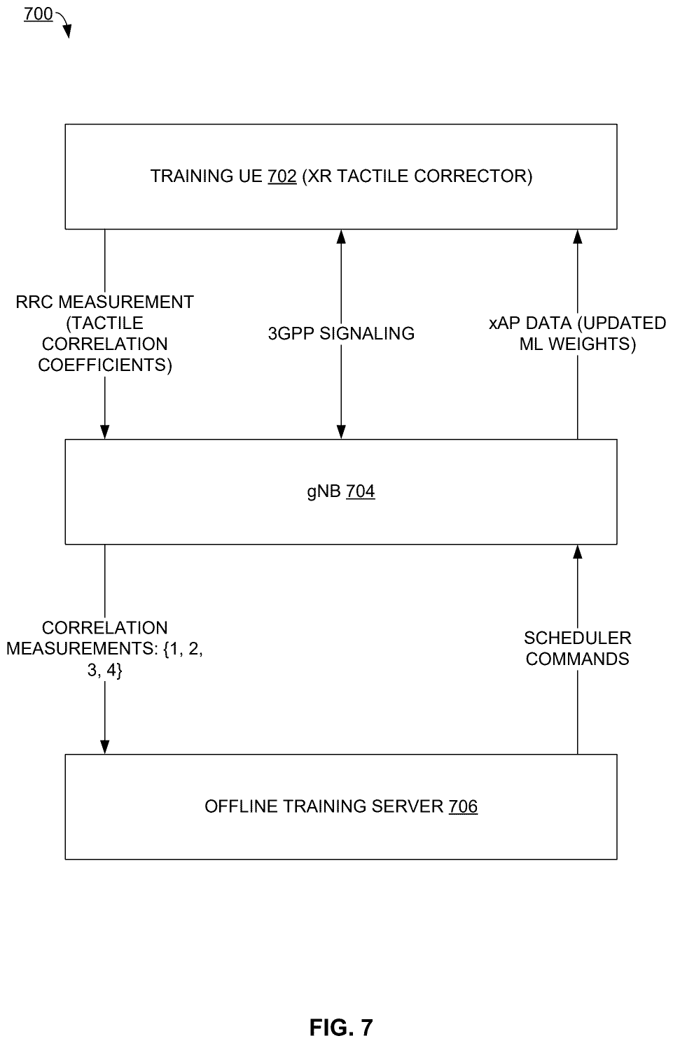

FIG. 7 illustrates an example system architecture 700 for machine learning model training, that can facilitate QoE based scheduling, in accordance with an embodiment of this disclosure. In some examples, one or more embodiments of system architecture 700 can be implemented by system architecture 100 of FIG. 1, or computing environment 1400 of FIG. 14.

System architecture 700 comprises training UE 702 (XR tactile corrector), gNB 704, and offline training server 706.

An example functional structure used to implement the present techniques can be as follows. For an ML (or artificial intelligence (AI) system, there can be training and inference.

In a training phase, the following can occur:
DRL network training can be conducted offline at a remote server. The server can collect experimental training experience from a testing XR unit as well as a gNB involved in the training phase.
A training XR UE unit can correlate a moving average vector of tactile measurements, such as depicted in table 600 of FIG. 6. These measurements can then be sent to an offline server as an input of the DRL system, for training.
The gNB can periodically send QoS measurements (see table 600) toward the offline training server.

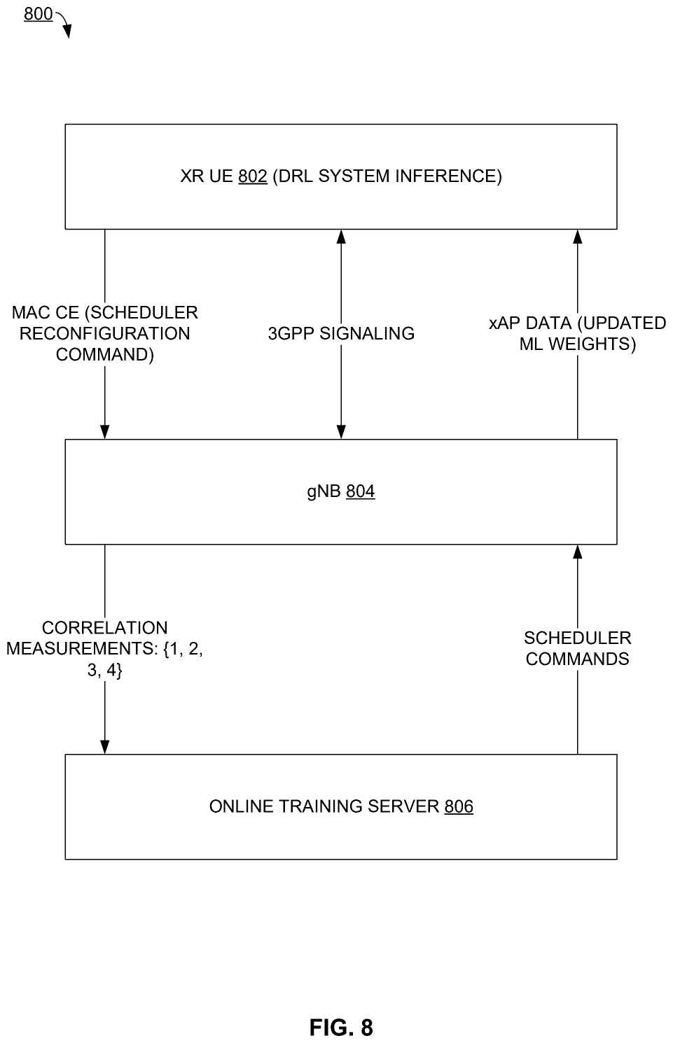

FIG. 8 illustrates an example system architecture 800 for machine learning model inference, that can facilitate QoE based scheduling, in accordance with an embodiment of this disclosure. In some examples, one or more embodiments of system architecture 800 can be implemented by system architecture 100 of FIG. 1, or computing environment 1400 of FIG. 14.

System architecture 800 comprises XR UE 802 (DRL system inference), gNB 804, and online training server 806.

An inference phase can be implemented as follows. Once a DRL system is trained, a gNB then will forward the weight vector and other design tuning parameters to a XR UE. This can be achieved through an xAP application, and can involve:
The XR UE can have a trained DRL network, and for a given input, an optimized bit sequence output can be produced and sent to the gNB scheduler to act accordingly.
The XR UE can use the QoS measurement acquired at the UE, instead of the receiving them from the gNB side.
During normal operations, the gNB can decide to update the DRL system weights on the UE side, which can be achieved through continuous learning at an online server (linked to the gNB).

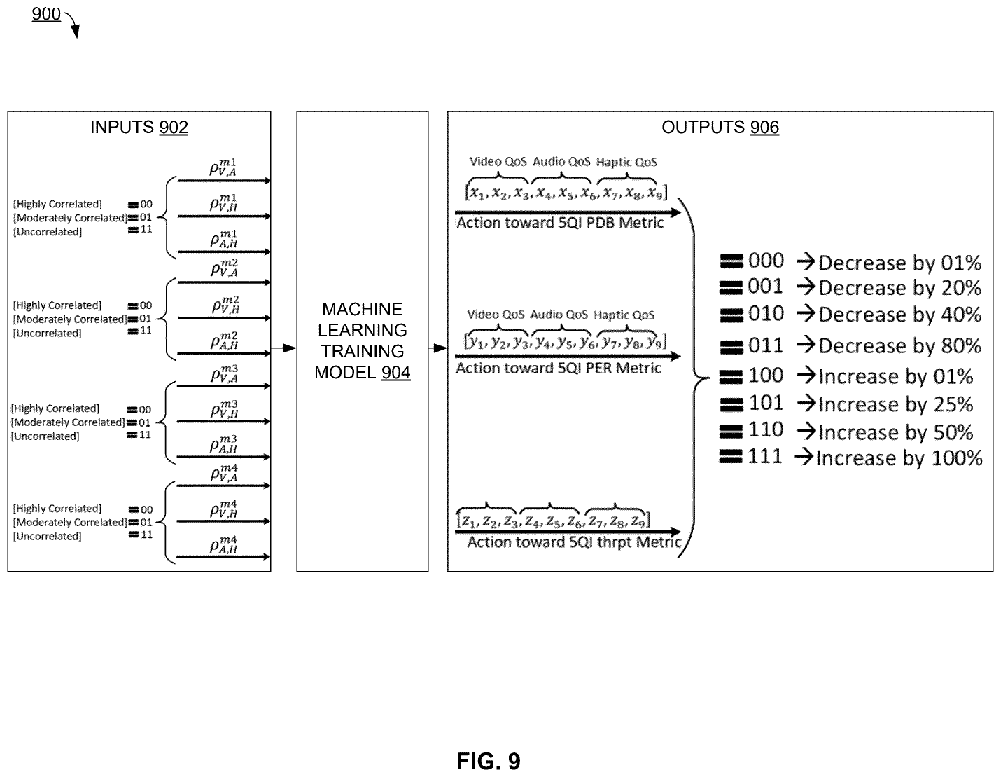

FIG. 9 illustrates another example system architecture 900 for machine learning model training, that can facilitate QoE based scheduling, in accordance with an embodiment of this disclosure. In some examples, one or more embodiments of system architecture 900 can be implemented by system architecture 100 of FIG. 1, or computing environment 1400 of FIG. 14.

System architecture 900 comprises inputs 902, machine learning training model 904, and outputs 906.

This illustrates an example of a DRL, including input-output binary mapping.

The digital mapping of the example input/output can comprise a quantization of the measurements/actions to avoid infinite state/action spaces.

In different examples of the present techniques, different types of ML models can be used.

A supervised learning system can be used, where a unique input produces a unique output.

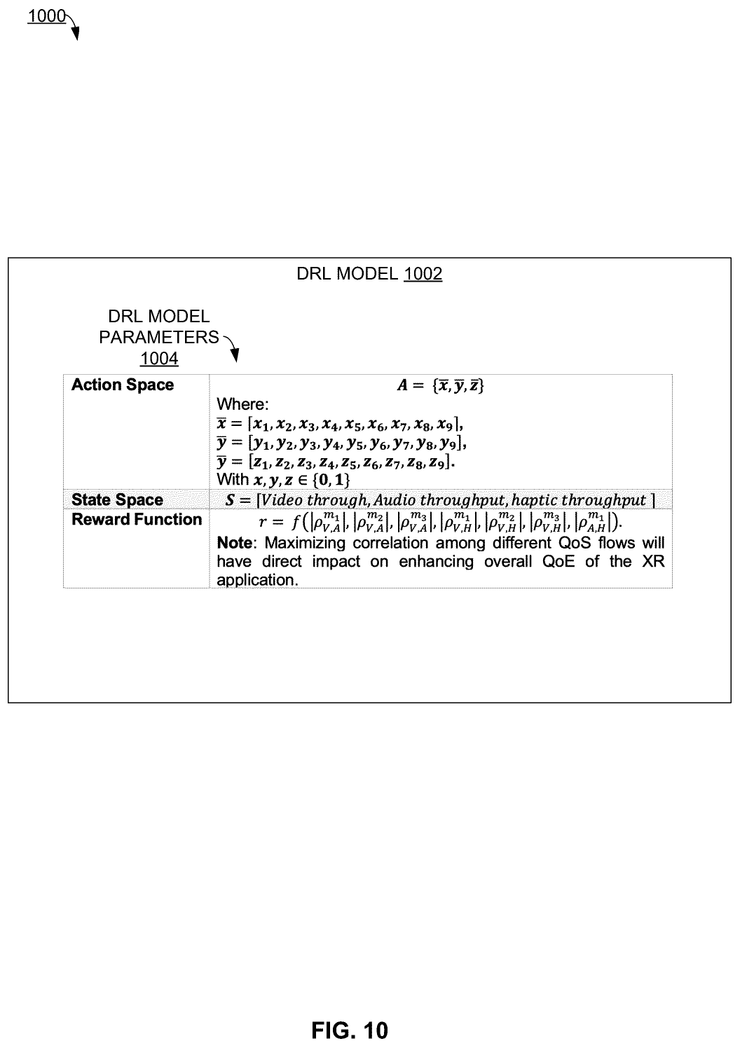

FIG. 10 illustrates another example system architecture 1000 for machine learning model training, and that can facilitate QoE based scheduling, in accordance with an embodiment of this disclosure. In some examples, one or more embodiments of system architecture 1000 can be implemented by system architecture 100 of FIG. 1, or computing environment 1400 of FIG. 14.

System architecture 1000 comprises DRL model 1002, and DRL parameters 1004.

A DRL system can utilize an agent to take an action to interact with the environment to produce a certain state vector. This action can result in either an increase or decrease on a certain reward function, the following example parameters can be mapped to a DRL system structure.

Values of correlation coefficients can be defined in table 1000.

In some examples, for more accurate performance, the correlation quantization levels can be increased to further detect smaller changes on correlation among different QoS flows. This can involve reporting an increased number of bits from the XR UE into the gNB (for the tactile feedback metrices).

In some examples, a DRL system can be trained online at the gNB side (or at online remote servers). Once trained, the updated weights can be transmitted a UE ML inference system through xAPs (or control data feedback).

The following performance metrics can be utilized in applying the present techniques. Latency can be used via a 5QI packet delay (ρDB). This can be a direct reflection of the QoS beam latency (either video, audio, or Haptic/Control). A 5QI measure can be a direct reflection of the frame transmission rate. It can discard unsuccessful reception by only introducing throughput. For audio clarity, available encoder/decoder (CODEC) data at the XR UE side can be utilized as a direct measure of video/audio clarity, responsiveness and other non-3^{rd} Generation Partnership Project (3GPP) measured parameters.

The present techniques can facilitate correlation-aware scheduling. By considering correlations between different QoS flows, such as video, audio, and haptic feedback, a scheduler can optimize delivery of each flow to enhance the overall user experience. This correlation-aware approach can ensure that the interdependencies between flows are considered, leading to improved synchronization and coherence in the XR experience. This correlation can be related to the statistical variations on traffic pattern for each QoS flow, irrespective of link quality. This, along with other metrices, can facilitate an immersive experience for XR UEs.

The present techniques can facilitate human perception-driven resource allocation. Human tolerance to distortions in XR applications can be leveraged. By prioritizing time-critical applications and allocating resources accordingly, it can be that slight distortions in less critical flows can be tolerated without significantly impacting the user experience. This human perception-driven resource allocation approach can ensure that resources are allocated in a way that maximizes the perceived quality and immersion for users.

The present techniques can facilitate comprehensive QoE measurement. The present QoE measurement techniques can capture a holistic perception of users in XR applications. They can incorporate factors such as latency, frame rate, audio clarity, haptic responsiveness, and overall immersion. This comprehensive QoE measurement can provide valuable feedback to a scheduler, and can enable it to optimize resource allocation based on user-centric criteria and continuously improve the user experience.

The present techniques can facilitate machine learning-based optimization. Machine learning techniques can be leveraged to optimize the scheduling process in XR applications. By training models on historical data, real-time feedback, and contextual information, a machine learning model can learn to make data-driven decisions for resource allocation. The model can continuously adapt and improve its scheduling strategy, leading to enhanced QoE. This machine learning-based optimization approach can provide a more adaptive and intelligent solution compared to prior rule-based heuristics.

### Example Process Flows

FIG. 11 illustrates an example process flow 1100 for QoE based scheduling, in accordance with an embodiment of this disclosure. In some examples, one or more embodiments of process flow 1100 can be implemented by system architecture 100 of FIG. 1, or computing environment 1400 of FIG. 14.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of process flow 300 of FIG. 3, process flow 400 of FIG. 4, process flow 500 of FIG. 5, process flow 1200 of FIG. 12, and/or process flow 1300 of FIG. 13.

Process flow 1100 begins with 1102, and moves to operation 1104.

Operation 1104 depicts receiving tactile correlation coefficients from at least one user equipment, the tactile correlation coefficients being generated by a trained deep reinforcement learning model, wherein the tactile correlation coefficients indicate respective correlations of respective outputs of an extended reality application of an extended reality application session established with the at least one user equipment via a broadband cellular network. Using the example of FIG. 7, process flow 1100 can be implemented by gNB 704, the user equipment can be training UE 702.

In some examples, the tactile correlation coefficients are received via radio resource control messaging. In some examples, the tactile correlation coefficients indicate a correlation between the at least two of the video data, the audio data, and the haptic data.

In some examples, operation 1104 comprises transmitting machine learning design tuning parameters to the at least one user equipment, where the trained deep reinforcement learning model is configured to utilize the machine learning design tuning parameters. This can be implemented in a similar manner as depicted with respect to FIGS. 7-8.

In some examples, the data comprises at least two of video data representative of at least one video signal, audio data representative of at least one sound signal, and haptic data representative of at least one haptic signal. This can be similar to the multiple QoS flows of FIG. 2.

After operation 1104, process flow 1100 moves to operation 1106.

Operation 1106 depicts scheduling data to transmit to the at least one user equipment based on the tactile correlation coefficients, to produce a scheduling. Continuing with the example of FIG. 7, gNB 704 can then schedule data to transmit to one or more UEs.

In some examples, the scheduling of the data comprises scheduling uplink data based on the tactile correlation coefficients, and scheduling downlink data based on the tactile correlation coefficients. That is, the present techniques can be applied to UL and or DL transmissions.

In some examples, the scheduling is performed by a gNodeB medium access control scheduler. That is, QoE data can be conveyed to a gNB MAC scheduler via MAC CEs.

After operation 1106, process flow 1100 moves to operation 1108.

Operation 1108 depicts transmitting the data to the at least one user equipment based on the scheduling. That is, the gNB of operation 1106 can then transmit the scheduled dat.

After operation 1108, process flow 1100 moves to 1110, where process flow 1100 ends.

FIG. 12 illustrates another example process flow 1200 for QoE based scheduling, in accordance with an embodiment of this disclosure. In some examples, one or more embodiments of process flow 1200 can be implemented by system architecture 100 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of process flow 300 of FIG. 3, process flow 400 of FIG. 4, process flow 500 of FIG. 5, process flow 1100 of FIG. 11, and/or process flow 1300 of FIG. 13.

Process flow 1200 begins with 1202, and moves to operation 1204.

Operation 1204 depicts facilitating receiving tactile correlation coefficients from a user equipment, the tactile correlation coefficients being generated by a trained deep reinforcement learning model, wherein the tactile correlation coefficients indicate respective correlations of respective outputs of an extended reality application of an extended reality application session, and wherein the extended reality application session is facilitated with the user equipment via a broadband cellular network. In some examples, operation 1204 can be implemented in a similar manner as operation 1104 of FIG. 11.

In some examples, operation 1204 comprises performing offline training of the trained deep reinforcement learning model. In some examples, the offline training comprises sending correlation measurements to a computer that is configured to perform the offline training, and receiving scheduler commands from the computer based on the correlation measurements. In some examples, the correlation measurements comprise a moving average vector.

In some examples, operation 1204 comprises sending quality-of-service metrics to computing equipment that is configured to perform the offline training.

In some examples, operation 1204 comprises sending, via an xAP application, a weight vector to the user equipment, the trained deep reinforcement learning model of the user equipment utilizing the weight vector as part of determining output from the trained deep reinforcement learning model. In some examples, operation 1204 comprises sending, via the xAP application, design tuning parameters to the user equipment, the trained deep reinforcement learning model of the user equipment utilizing the design tuning parameters as part of determining output from the trained deep reinforcement learning model, wherein the design tuning parameters are separate from the weight vector.

This can be implemented in a similar manner as described with respect to FIG. 7.

After operation 1204, process flow 1200 moves to operation 1206.

Operation 1206 depicts scheduling data to transmit to the user equipment based on the tactile correlation coefficients, to produce a scheduling. In some examples, operation 1206 can be implemented in a similar manner as operation 1106 of FIG. 11.

After operation 1206, process flow 1200 moves to operation 1208.

Operation 1208 depicts facilitating transmitting the data to the user equipment based on the scheduling. In some examples, operation 1208 can be implemented in a similar manner as operation 1108 of FIG. 11.

After operation 1208, process flow 1200 moves to 1210, where process flow 1200 ends.

FIG. 13 illustrates another example process flow 1300 for QoE based scheduling, in accordance with an embodiment of this disclosure. In some examples, one or more embodiments of process flow 1300 can be implemented by system architecture 100 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of process flow 300 of FIG. 3, process flow 400 of FIG. 4, process flow 500 of FIG. 5, process flow 1100 of FIG. 11, and/or process flow 1200 of FIG. 12.

Process flow 1300 begins with 1302, and moves to operation 1304.

Operation 1304 depicts receiving tactile correlation coefficients from a user equipment, the tactile correlation coefficients being generated by a machine learning model, wherein the tactile correlation coefficients indicate respective correlations of respective outputs of an extended reality application of an extended reality application session, and wherein the extended reality application session is facilitated with the user equipment via network equipment of a broadband cellular network. In some examples, operation 1304 can be implemented in a similar manner as operation 1104 of FIG. 11.

In some examples, operation 1304 comprises sending, to the user equipment, a quality-of-service measurement, for the user equipment to input the quality-of-service measurement to the machine learning model. In some examples, the receiving of the tactile correlation coefficients comprises receiving the tactile correlation coefficients based on the user equipment generating a quality-of-service measurement at the user equipment, and inputting the quality-of-service measurement to the machine learning model. That is, a XR UE can utilize a QoS measurement acquired at a UE, or a QoS measurement received from a gNB.

In some examples, the machine learning model comprises first model weights, and operation 1304 comprises sending updated model weights to the user equipment, the user equipment utilizing the updated model weights with the machine learning model. That is, a gNB can update the DRL system weights on the UE side, which can be achieved through continuous learning at an online server (linked to the gNB). This can be implemented in a similar manner as described with respect to FIG. 8.

In some examples, the machine learning model comprises a deep reinforcement learning model, and a state space of the deep reinforcement learning model comprises a video throughput, an audio throughput, and a haptic throughput.

In some examples, the machine learning model comprises a deep reinforcement learning model, and a reward function of the deep reinforcement learning model is based on a first correlation between video data of the extended reality application and audio data of the extended reality application, a second correlation between the video data and haptic feedback of the extended reality application, and a third correlation between the audio data and the haptic feedback. This can be implemented in a similar manner as described with respect to FIG. 10.

After operation 1304, process flow 1300 moves to operation 1306.

Operation 1306 depicts scheduling data to transmit to the user equipment based on the tactile correlation coefficients. In some examples, operation 1306 can be implemented in a similar manner as operation 1206 of FIG. 11.

After operation 1306, process flow 1300 moves to 1308, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of base station 102 and/or UEs 104 of FIG. 1.

In some examples, computing environment 1400 can implement one or more embodiments of the process flows of FIGS. 3-5 and/or 10-12 to facilitate QoE based scheduling.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples, and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1416 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving tactile correlation coefficients from at least one user equipment, the tactile correlation coefficients being generated by a trained deep reinforcement learning model, wherein the tactile correlation coefficients indicate respective correlations of respective outputs of an extended reality application of an extended reality application session established with the at least one user equipment via a broadband cellular network;
scheduling data to transmit to the at least one user equipment based on the tactile correlation coefficients, to produce a scheduling; and
transmitting the data to the at least one user equipment based on the scheduling.

2. The system of claim 1, wherein the operations further comprise:
transmitting machine learning design tuning parameters to the at least one user equipment, wherein the trained deep reinforcement learning model is configured to utilize the machine learning design tuning parameters.

3. The system of claim 1, wherein the tactile correlation coefficients are received via radio resource control messaging.

4. The system of claim 1, wherein the data comprises at least two of video data representative of at least one video signal, audio data representative of at least one sound signal, and haptic data representative of at least one haptic signal.

5. The system of claim 4, wherein the tactile correlation coefficients indicate a correlation between the at least two of the video data, the audio data, and the haptic data.

6. The system of claim 1, wherein the scheduling of the data comprises:
scheduling uplink data based on the tactile correlation coefficients; and
scheduling downlink data based on the tactile correlation coefficients.

7. The system of claim 1, wherein the scheduling is performed by a gNodeB medium access control scheduler.

8. A method, comprising:
facilitating, by a system comprising at least one processor, receiving tactile correlation coefficients from a user equipment, the tactile correlation coefficients being generated by a trained deep reinforcement learning model, wherein the tactile correlation coefficients indicate respective correlations of respective outputs of an extended reality application of an extended reality application session, and wherein the extended reality application session is facilitated with the user equipment via a broadband cellular network;
scheduling, by the system, data to transmit to the user equipment based on the tactile correlation coefficients, to produce a scheduling; and
facilitating, by the system, transmitting the data to the user equipment based on the scheduling.

9. The method of claim 8, further comprising:
performing, by the system, offline training of the trained deep reinforcement learning model.

10. The method of claim 9, wherein the offline training comprises:
sending correlation measurements to a computer that is configured to perform the offline training; and
receiving scheduler commands from the computer based on the correlation measurements.

11. The method of claim 10, wherein the correlation measurements comprise a moving average vector.

12. The method of claim 9, where the offline training comprises:
sending quality-of-service metrics to computing equipment that is configured to perform the offline training.

13. The method of claim 8, further comprising:
sending, by the system and via an xAP application, a weight vector to the user equipment, the trained deep reinforcement learning model of the user equipment utilizing the weight vector as part of determining output from the trained deep reinforcement learning model.

14. The method of claim 13, further comprising:
sending, by the system and via the xAP application, design tuning parameters to the user equipment, the trained deep reinforcement learning model of the user equipment utilizing the design tuning parameters as part of determining output from the trained deep reinforcement learning model, wherein the design tuning parameters are separate from the weight vector.

15. A non-transitory computer-readable medium comprising instructions that, in response to execution, cause a system comprising at least one processor to perform operations, comprising:
receiving tactile correlation coefficients from a user equipment, the tactile correlation coefficients being generated by a machine learning model, wherein the tactile correlation coefficients indicate respective correlations of respective outputs of an extended reality application of an extended reality application session, and wherein the extended reality application session is facilitated with the user equipment via network equipment of a broadband cellular network; and
scheduling data to transmit to the user equipment based on the tactile correlation coefficients.

16. The non-transitory computer-readable medium of claim 15, wherein the operations further comprise:
sending, to the user equipment, a quality-of-service measurement, for the user equipment to input the quality-of-service measurement to the machine learning model.

17. The non-transitory computer-readable medium of claim 15, wherein the receiving of the tactile correlation coefficients comprises receiving the tactile correlation coefficients based on the user equipment generating a quality-of-service measurement at the user equipment, and inputting the quality-of-service measurement to the machine learning model.

18. The non-transitory computer-readable medium of claim 15, wherein the machine learning model comprises first model weights, and wherein the operations further comprise:
sending updated model weights to the user equipment, the user equipment utilizing the updated model weights with the machine learning model.

19. The non-transitory computer-readable medium of claim 15, wherein the machine learning model comprises a deep reinforcement learning model, and wherein a state space of the deep reinforcement learning model comprises a video throughput, an audio throughput, and a haptic throughput.

20. The non-transitory computer-readable medium of claim 15, wherein the machine learning model comprises a deep reinforcement learning model, and wherein a reward function of the deep reinforcement learning model is based on a first correlation between video data of the extended reality application and audio data of the extended reality application, a second correlation between the video data and haptic feedback of the extended reality application, and a third correlation between the audio data and the haptic feedback.
